(19) United States
(12) Patent Application Publication
(10) Pub. No.: US 2014/0248813 A1
(43) Pub. Date: Sep. 4, 2014

(54) CRYSTAL-CLEAR POLYURETHANES

(71) Applicant: BASF SE, Ludwigshafen (DE)

(72) Inventors: Patrick BOLZE, Osnabrueck (DE); Lars Goedke, Marl (DE); Franz Xaver Redl, Lemfoerde (DE); Gerd Westermann, Diepenau (DE)

(73) Assignee: BASF SE, Ludwigshafen (DE)

(21) Appl. No.: 14/196,351

(22) Filed: Mar. 4, 2014

Related U.S. Application Data
(60) Provisional application No. 61/771,967, filed on Mar. 4, 2013.

(51) Int. Cl. C08G 18/78; C09D 175/08

(52) U.S. Cl. CPC C08G 18/7831; C09D 175/08
USPC 442/179; 528/66; 524/590; 428/425.6; 428/425.1; 428/423.1; 442/180

(57) ABSTRACT

The present invention relates to processes for preparing compact transparent polyurethanes by mixing (a) isocyanates with (b) compounds having at least two isocyanate-reactive groups, (c) catalysts, and optionally (d) auxiliaries and additives to give a reaction mixture and carrying out reaction to the compact transparent polyurethanes, the isocyanates (a) comprising at least 50 wt % of biurets of hexamethylene diisocyanate. The present invention further relates to a compact, transparent polyurethane prepared by a process of the invention, and to the use of such a compact, transparent polyurethane as a surface coating, more particularly in the interior of means of transport.

The present invention relates to processes for preparing compact, transparent polyurethanes by mixing (a) isocyanates with (b) compounds having at least two isocyanate-reactive groups, (c) catalysts, and optionally (d) auxiliaries and additives to give a reaction mixture and carrying out reaction to the compact transparent polyurethanes, the isocyanates (a) comprising at least 50 wt % of biurets of hexamethylene diisocyanate. The present invention further relates to a compact, transparent polyurethane prepared by a process of the invention, and to the use of such a compact, transparent polyurethane as a surface coating, more particularly in the interior of means of transport.

Compact, transparent polyurethanes are known and are in common use. One preferred field of use is that of the coating of areas in interiors of motor vehicles, more particularly the coating of wooden inlays. Other preferred fields of use are as a glass substitute, for sunroofs, front, rear, and side windows in automobile and aircraft construction, for example, and as coatings of lamps or of solar installations, and also coatings for technical equipment.

Transparent polyurethanes of this kind are customarily prepared by reaction of aliphatic polyisocyanates with compounds which contain groups that are reactive with isocyanate groups. Customary aliphatic isocyanates are hexamethylene diisocyanates (HDI) and isophorone diisocyanates (IPDI). Since these aliphatic isocyanates have a very high vapor pressure, and since the inhalation of isocyanate-containing vapors is greatly hazardous to health, these isocyanates are customarily employed in the form of oligomers, more particularly dimers (uretdiones) and trimers (isocyanurates).

Compact transparent polyurethanes based on aliphatic isocyanates, of the kind used more particularly in the interior of motor vehicles, are described in numerous documents.

JP2005133013 describes a compact transparent polyurethane which is prepared using a mixture of isocyanurates of HDI and IPDI. As compounds having at least two hydrogen atoms reactive with isocyanate groups, caprolactone-based polyols are used. These polyols are expensive to prepare.

DE102004011348A1 describes the preparation of polyurethanes of this kind using, as isocyanates, monomeric aliphatic isocyanates or prepolymers thereof. A mixture of various metal catalysts is the catalyst used. This catalyst mixture is very sensitive in its processing; moreover, monomeric isocyanates are toxic.

DE1041295 describes the preparation of a prepolymer from HDI or IPDI and a polyol. After the prepolymer has been prepared, monomeric HDI or IPDI must be removed by distillation, since these monomers are toxic and volatile. This process requires a high level of cost and complexity.

DE19811289 describes the preparation of hard, transparent polyurethanes, using a mixture of isocyanurates of HDI and IPDI. Described as polyols are mixtures which comprise polyether alcohols and polyester alcohols. Polyols of these kinds are frequently incompatible. This leads to mixing problems in the course of processing. Moreover, polyurethanes based on polyester alcohols usually have inadequate stability toward hydrolysis.

DE10209047214 describes a transparent polyurethane which is obtained using a mixture of HDI isocyanurate and IPDI isocyanurate. A disadvantage is that IPDI isocyanurates are solid and must first be dissolved before processing.

EP 402212 describes a process for producing compact transparent polyurethane coatings, especially for laminated safety glazing systems, based on aliphatic isocyanates having self-healing properties. Monomeric, aliphatic isocyanates are used, more particularly HDI trimers, which are trimerized immediately prior to the polyurethane reaction. This procedure is very costly and inconvenient; moreover, monomeric aliphatic isocyanate is difficult to handle on account of the high vapor pressure. The polyurethanes are prepared at 120°. Furthermore, the use of trimeric HDI isocyanurate results in impaired elongation at break.

Other disadvantages of known, transparent polyurethanes are less-than-ideal scratch resistance and mechanical properties, such as tensile strength. Moreover, the aim is to supply a polyurethane system which can be processed quickly and easily into homogeneous, transparent polyurethanes.

It was an object of the present invention, therefore, to supply a scratch-resistant, transparent polyurethane which has self-healing properties and very good mechanical properties. A further object was to supply a simple process for preparing such a polyurethane that can be carried out reliably even at low temperatures of less than 100° C.

The object according to the invention is achieved by means of a process for preparing compact, transparent polyurethanes by mixing (a) isocyanates with (b) compounds having at least two isocyanate-reactive groups, (c) catalysts, and optionally (d) auxiliaries and additives to give a reaction mixture and carrying out reaction to the compact transparent polyurethanes, the isocyanates (a) comprising at least 50 wt % of biurets of hexamethylene diisocyanate.

Compact polyurethanes are understood in the context of this invention to be polyurethane prepared without addition of blowing agents. The polyols used, however, may possibly contain traces of residual water. The residual water content is preferably below 1 wt %, more preferably below 0.3 wt %, based on the total weight of the polyols used. Polyurethanes are designated transparent if text in font size 3 (Arial font) in black on white paper can be read through a 5 mm sheet of polyurethane of the invention when the sheet is lying directly on the text.

Isocyanates (a) contemplated include all aliphatic or cycloaliphatic polyisocyanates, preferably diisocyanates. The following are specific examples: aliphatic diisocyanates, such as hexamethylene 1,6-diisocyanate, 2-methylpentamethylene 1,5-diisocyanate, and cycloaliphatic diisocyanates, such as isophorone diisocyanate or cyclohexane 1,4-diisocyanate.

The isocyanates (a) are preferably not used in their monomeric form, but instead comprise isocyanate prepolymers, isocyanurates, allophanates, or biurets. These isocyanates are known and may be acquired commercially. It is essential to the present invention that the aliphatic isocyanate (a) comprises at least 50 wt %, preferably at least 80 wt %, more preferably at least 90 wt %, and more particularly substantially exclusively biurets of hexamethylene diisocyanate (ai).

“Substantially exclusively biurets of hexamethylene diisocyanate (ai)” here means that apart from biurets of hexamethylene diisocyanate, no further isocyanates are added. Disregarded in this context are byproducts obtained during preparation of biuret of hexamethylene diisocyanate (ai), and amounts of byproducts, or unreacted starting compounds, that cannot be removed by customary methods such as distillation. The amount of such byproducts and unreacted starting compounds is preferably not more than 2.5 wt %, more preferably not more than 1 wt %, and more particularly not more than 0.5 wt %, based on the total weight of the biuret of hexamethylene diisocyanate (ai). Alongside aliphatic isocyanates and cycloaliphatic isocyanates there are preferably no aromatic isocyanates used, since the latter are usually not lightfast, and tend to yellow over time on exposure to light.

The biurets of hexamethylene diisocyanate (ai) may be obtained commercially, from BASF under the trade name Basonat® HB, for example. They are customarily obtained by reaction of monomeric hexamethylene diisocyanate with amines, as for example diamines, such as ethylenediamine, or with water, optionally with the use of a catalyst. Biurets of hexamethylene diisocyanate (ai) used with preference are compounds which are obtained by reaction of monomeric hexamethylene diisocyanate and water.

The isocyanates (a) preferably have an average NCO content of 26.5 to 16 wt %, more preferably 20 to 24 wt %, and more particularly 21 to 23 wt %. The viscosity of the isocyanates (a) at 60° C. is preferably less than 1000 mPas, more preferably less than 750 mPas, and more particularly less than 500 mPas.

As compounds having at least two isocyanate-reactive groups (b) it is possible to use, for example, polyetherols, polyesterols, and low molecular mass alcohols or amines. Compounds having at least two isocyanate-reactive groups (b) preferably have an average molar functionality of 1.5 to 6, preferably of 2 to 5, and an average OH number of 100 to 950.

The compounds having at least two isocyanate-reactive groups (b) preferably comprise polyetherols and low molecular mass alcohols.

The polyether alcohols that are used in component b) are obtainable by conventional addition reaction of alkylene oxides with compounds which have at least two hydrogen atoms that are reactive with alkylene oxides.

The polyether alcohols are prepared by known processes, usually by catalytic addition reaction of alkylene oxides, more particularly ethylene oxide and/or propylene oxide, more preferably propylene oxide, with H-functional starter substances, such as polyfunctional alcohols. Starter substances employed with preference are water, dihydric alcohols, as for example ethylene glycol, propylene glycol, or butanediols, trihydric alcohols, such as glycerol or trimethylolpropane, for example, and also alcohols with higher functionality, such as pentaerythritol, sugar alcohols, as for example sucrose, glucose, or sorbitol, and also aromatic diols, examples being bisphenol A, bisphenol F, and bisphenol S. Catalysts employed for the addition reaction of the alkylene oxides include, in particular, basic compounds, with potassium hydroxide having the greatest industrial significance here.

As low molecular mass alcohols it is possible, for example, to use dihydric, trihydric or tetrahydric alcohols, such as ethanediol, propane-1,2- and -1,3-diol, diethylene glycol, dipropylene glycol, butane-1,4-diol, hexane-1,6-diol, glycerol and/or pentaerythritol, preferably dipropylene glycol. Component (b) preferably comprises 2 to 40, more preferably 5 to 25, and more particularly 10 to 20 wt % of low molecular mass alcohol.

The compounds having at least two isocyanate-reactive groups (b) preferably comprise at least one polyether alcohol and/or one low molecular mass alcohol (bi) having a functionality of 2 to 5, preferably 2.5 to 3.5, and an OH number of more than 600 to 950 mg KOH/g, preferably 700 to 900 mg KOH/g and more particularly 800 to 900 mg KOH/g, and at least one polyether alcohol (bii) having a functionality of 2 to 5, preferably 2.5 to 3.5, and an OH number of 50 to 600 mg KOH/g, preferably 100 to 500 mg KOH/g, and more preferably 150 to 450 mg KOH/g.

Compounds having at least two isocyanate-reactive groups (b), as well as the compounds (bi), (bii) and low molecular mass alcohol, preferably comprise less than 20 wt %, more preferably less than 10 wt %, with further preference less than 5 wt %, based on the total weight of component (b), of other compounds having isocyanate-reactive groups. Besides the compounds (bi) and (bii), component (b) more particularly comprises no further compounds having isocyanate-reactive groups.

The weight ratio of the polyether alcohols (bi) to the polyether alcohols (bii) is preferably 1:1 to 1:6, more preferably 1:1.5 to 1:4.5, and more particularly 1:1.8 to 1:3.5. One particularly preferred embodiment of the present invention uses, as compounds having isocyanate-reactive groups, compounds which, based on the total number of OH groups in component (b), have at least 70%, more preferably at least 85%, of secondary OH groups. The compounds used in component (b) preferably have an average functionality of 2.3 to 3.5, more preferably 2.5 to 2.99.

The reaction of the compounds having isocyanate-reactive groups (b) with the isocyanates takes place customarily in the presence of catalysts and customary auxiliaries and/or additives.

As catalysts for preparing the polyurethane foams of the invention it is possible to use the customary and known polyurethane formation catalysts, examples being organic compounds of tin, zinc, titanium, zirconium, aluminum, iron and/or bismuth, more particularly tin compounds and/or bismuth compounds, such as tin diacetate, tin dioctoate, dialkyltin dilaurate, dialkyltin carboxylate, dialkyltin thiocarboxylate, dialkyltin mercaptide, bismuth carboxylate, and/or strongly basic amines such as triethylamine, pentamethyldiethylenetriamine, tetramethyldiaminoethyl ether, 1,2-dimethylimidazole, dimethylcyclohexylamine, dimethylbenzylamine, or, preferably, triethylenediamine. The catalysts are used preferably in an amount of 0.01 to 5 wt %, preferably 0.05 to 2 wt %, based on the weight of the compounds having at least two active hydrogen atoms. Preferably only metal catalysts are used, since with amine catalysts it is never possible entirely to rule out a polyurethane odor, which is highly deleterious for motor vehicle interiors. Moreover, the amines may lead to discoloration of the polyurethane.

Auxiliaries and/or additives (d) that can be used are all adjuvants customary in the production of the coatings of the invention, such as surface-active substances, fillers, lubricants and mold release aids, dyes and pigments, antioxidants, against hydrolysis, light, heat, or discoloration, for example, metal deactivators, organic and/or inorganic fillers, and plasticizers. Hydrolysis inhibitors used are preferably oligomeric and/or polymeric, aliphatic or aromatic carbodiimides.

To stabilize the transparent polyurethanes of the invention against aging, stabilizers are preferably employed. Stabilizers in the sense of the present invention are additives which protect a plastic or a mixture of plastics from harmful environmental effects. Examples are primary and secondary antioxidants, hindered amine light stabilizers, UV absorbers, hydrolysis inhibitors, quenchers, and flame retardants. Examples of commercial stabilizers are given in Plastics Additive Handbook, 5th edition, H. Zweifel, ed., Hanser Publishers, Munich, 2001 ([1]), pp. 98-136.

If the transparent polyurethane of the invention is exposed to thermooxidative damage in the course of its use, antioxidants may be added. Phenolic antioxidants are used with preference. Examples of phenolic antioxidants are given in Plastics Additive Handbook, 5th edition, H. Zweifel, ed., Hanser Publishers, Munich, 2001, pp. 98-107 and pp. 116-121.

If transparent polyurethane of the invention is exposed to UV light, it preferably further comprises a UV absorber. UV absorbers are molecules which absorb high-energy UV light and dissipate the energy. Common UV absorbers which find use in the art belong, for example, to the group of the cinnamic esters, the diphenylcyanoacrylates, the formamidines, the benzylidenemalonates, the diarylbutadienes, triazines, and the benzotriazoles. Examples of commercial UV absorbers are found in Plastics Additive Handbook, 5th edition, H. Zweifel, ed., Hanser Publishers, Munich, 2001, pages 116-122.

UV stabilization as described above, based on an antioxidant and a UV absorber, is often still not sufficient to ensure effective stability of the transparent polyurethane of the invention against the damaging influence of UV rays. In this case, a hindered amine light stabilizer (HALS) may be employed as component (e), preferably additionally to the antioxidant and the UV absorber. The activity of the HALS compounds derives from their capacity to form nitroxyl radicals, which engage in the mechanism of the oxidation of polymers. HALS are considered highly efficient UV stabilizers for the majority of polymers. HALS compounds are general knowledge and available commercially. Examples of commercially available HALS stabilizers are given in Plastics Additive Handbook, 5th edition, H. Zweifel, Hanser Publishers, Munich, 2001, pp. 123-136.

Plasticizers which can be used are all plasticizers known for use in polyurethanes. They include, for example, compounds which comprise at least one phenolic group. Such compounds are described in EP 1529814.

Further details of the abovementioned auxiliaries and additives can be found in the technical literature—for example, from Plastics Additive Handbook, 5th edition, H. Zweifel, ed., Hanser Publishers, Munich, 2001. All molecular weights stated in this specification have the unit [g/mol].

For the production of the coatings, the auxiliaries and/or additives (d) are usually combined with the compounds having at least two hydrogen atoms that are reactive with isocyanate groups, to form what is called a polyol component.

The process of the invention can be used to produce transparent coatings. These coatings preferably have a thickness of 0.1-3 mm. These topcoats may be used, for example, for protecting surfaces, such as in the area of the dashboard of motor vehicles, for example.

For preparing the polyurethanes of the invention, the starting components are mixed customarily at a temperature of 0-100° C., preferably of 20-80° C., and the mixture is introduced into the open mold tool or, optionally under pressure, into the closed mold tool. Mixing may be performed mechanically by means of a stirrer or with a high-pressure mixing head. The mold temperature and the temperature of the input components is preferably less than 100° C., more preferably less than 90° C., and more particularly less than 75° C. This allows energy-efficient production of the coating and extensive preservation of the material to be coated.

The components for preparing the transparent polyurethane of the invention are reacted here in amounts such that the equivalents ratio of NCO groups of the isocyanate groups to the sum of the isocyanate-reactive hydrogen atoms is preferably 1:0.85 to 1:1.50, more preferably 1:0.90 to 1:1.30, very preferably 1:0.95 to 1:1.20, and more particularly 1:1.00 to 1.15.

The process of the invention can also be used to produce transparent coatings. These coatings preferably have a thickness of 0.1-3 mm. If an article is to be coated with the polyurethane of the invention, the article is preferably inserted into the mold before the components of the polyurethane system are introduced. These topcoats may be used, for example, to protect surfaces, in the area of the dashboard of motor vehicles, for example. Such articles to be coated may consist, for example, of glass, natural substances, such as wood, woven or knitted fabrics, such as carbon fiber mats or glass fiber mats, or plastics, such as polycarbonates or ABS.

The reaction, after a time of 0.5-15 minutes, is usually concluded to an extent such that the polyurethane can be removed from the mold.

The coatings as well are customarily also produced in a mold. In that case, the article to be coated is inserted into the mold in such a way that the liquid starting components of the coating can be applied into the mold onto the surface that is to be coated. Thereafter the mold is closed and the mixed starting components of the coating are introduced as described above into the mold.

It is in principle also possible to produce the compact coating separately to the article to be coated, and thereafter to apply it to the surface, by means of adhesive bonding, for example.

By mechanical working, sanding for example, the surface may subsequently be further improved—for example, by polishing, and/or a combination of sanding and polishing.

The polyurethanes of the invention usually have a density in the 0.95-1.20 g/cm³ range and a hardness of preferably 80 shore A to 80 shore D, more preferably 85 shore A to 70 shore D, very preferably shore A 90 to 60 shore D.

The polyurethanes of the invention may be used as a glass substitute, as for example for sun roofs, front, rear, and side windows in automobile and aircraft construction, and as covers for lamps or solar installations and technical equipment, or as coatings, such as in motor vehicle interiors, for example, with the surface to be coated preferably being wood. Particularly in the context of the coating of lighting means or as glass substitute, such as in the production of windows, for example, the polyurethane of the invention may also comprise substances which absorb light, allowing the window to be tinted or colored.

The present invention yields a scratch-resistant, preferably self-healing, transparent polyurethane which has very good mechanical properties and which can be produced at low mold temperatures and component temperatures, thereby saving on energy and possibly protecting material to be coated from excessive thermal loading. Moreover, the material of the invention is easy to prepare, since the mixing ratio of isocyanate component and polyol component is in the range from 1:1 to 1:2, hence minimizing the risk of defects in material as a result of incomplete mixing. Furthermore, the present material exhibits self-healing effects on scratching, with the surface remaining appealing and scratch-free even in lengthy service.

The intention below is to illustrate the present invention with examples.

Ingredients
Polyol 1: polyether polyalcohol having a hydroxyl number of 860 mg KOH/g, prepared by reacting trimethylolpropane with propylene oxide.
Polyol 2: polyether polyalcohol having a hydroxyl number of 160 mg KOH/g, prepared by reacting trimethylolpropane with propylene oxide.
Alcohol: dipropylene glycol
Catalyst A: tin catalyst (dimethyltin carboxylate)
Catalyst B: tin catalyst (dioctyltin thioglycolate)
Additives: stabilizers; blocking agents, internal release agents.
Isocyanate 1: isophorone diisocyanate-based prepolymer, obtainable from 100 parts by weight of isophorone diisocyanate, 15 parts by weight of a polyether polyol based on trimethylolpropane/propylene oxide with a molecular weight of 192 g/mol, and 15 parts by weight of a polyester polyol based on adipic acid/diethylene glycol/trimethylolpropane with a molecular weight of 2400 g/mol. The completed prepolymer had an NCO content of 20.4 wt %. The viscosity at 60° C. is 1740 mPas.
Isocyanate 2: trimerized aliphatic polyisocyanate based on isophorone diisocyanate and hexamethylene 1,6-diisocyanate, NCO content 20.7%. The viscosity at 60° C. is 1190 mPas.
Isocyanate 3: biuretized isocyanate based on hexamethylene 1,6-diisocyanate with water, NCO content 22.8%. The viscosity at 60° C. is 335 mPas.

The ingredients as per Table 1 were mixed for an isocyanate index of 100, and the mixture was introduced into a mold and processed into transparent polyurethanes. The amounts of the ingredients in the polyol component are indicated in parts by weight. The viscosity was determined in accordance with DIN EN ISO 3219, the Shore hardness with DIN 53505, elongation at break with DIN EN ISO 527, and the scratch resistance by scratching with an Erichsen 318 S testing rod with a force of 10 N in accordance with ISO 1518 using a hemispherical tip with 0.75 mm diameter.

| | Comparative | Comparative | Comparative | Comparative | |
|---|---|---|---|---|---|
| Polyol | 1 | 2 | 3 | 4 | Example |
| Polyol 1 | 64.00 | 97.30 | 97.30 | 97.30 | 15.00 |
| Polyol 2 | 32.00 | | | | 67.35 |
| Alcohol | | | | | 15.00 |
| Additives | 2.45 | 2.45 | 2.45 | 2.45 | 2.45 |
| Catalyst A | 1.05 | 0.25 | 0.50 | 0.25 | 0.50 |
| Catalyst B | 0.50 | | | | |
| Isocyanate | | | | | |
| Isocyanate 1 | 100.00 | | | | |
| Isocyanate 2 | | 100.00 | 100.00 | 100.00 | |
| Isocyanate 3 | | | | | 100.00 |
| Mixing ratio 100: | 222 | 314 | 314 | 314 | 127 |
| Sheet demold | 120 | 120 | | | 45 |
| time [s] | | | | | |
| Component | 80 | 80 | 80 | 60 | 60 |
| temp. [° C.] | | | | | |
| Tool surface | 80 | 90 | 90 | 60 | 60 |
| temp. [° C.] | | | | | |
| Open time [s] | 6 | 10 | | | 8.5-9 |
| Shore hardness D | 85 | 86 | | | |
| Shore hardness A | | | | | 90 |
| Elongation at | 10 | 13 | | | 80 |
| break [%] | | | | | |
| Scratch | severe | light scratch | | | scratch |
| resistance | scratch | | | | disappears |

In comparative examples 3 and 4, transparent moldings were not obtained. Thus, the system from comparative experiment 3 had a reactivity, for an 80° C. mold and component temperature, which was such that the mold could not be completely filled. In comparative experiment 4, the viscosity of the isocyanate component at 60° C. was at a level which meant that the two components could not be fully mixed.

The examples demonstrate that in accordance with a process of the invention, with a low mold and component temperature and a short demold time, transparent polyurethanes are obtained that have outstanding mechanical properties.

1. A process for preparing a compact, transparent polyurethane, the process comprising mixing
a) an isocyanate with
b) a compound having at least two isocyanate-reactive groups,
c) a catalyst, and optionally
d) optionally an auxiliary, an additive, or both, to obtain a reaction mixture,. and
reacting the reaction mixture to obtain a compact transparent polyurethane,
wherein the isocyanate (a) comprises at least 50 wt % of biurcts a biuret of hexamethylene diisocyanate (ai).

2. The process according to claim 1, wherein the isocyanate (a) comprises at least 90 wt % of the biuret of hexamethylene diisocyanate (ai).

3. The process according to claim 1, wherein the biuret of hexamethylene diisocyanate (ai) is obtained by a reaction of hexamethylene diisocyanate with water.

4. The process according to claim 1, wherein the isocyanate (a) has an average NCO content of 26.5 to 16 wt %.

5. The process according to claim 1, wherein the compound having at least two isocyanate-reactive groups (b) comprises:
a polyether alcohol (bi) having a functionality of 2 to 5 and an OH number of more than 600 to 950, and
a polyether alcohol (bii) having a functionality of 2 to 5 and an OH number of 50 to 600.

6. The process according to claim 5, wherein a weight ratio of the polyether alcohol (bi) to the polyether alcohol (bii) is in a range of 1:1 to 1:6.

7. The process according to claim 5, wherein the compound having at least two isocyanate-reactive groups (b) comprises no polyols other than the polyether polyol (bi) and the polyether polyol (bii).

8. The process according to claim 1, wherein the polyol (b) has at least 70% of secondary OH groups.

9. The process according to claim 1, wherein the polyol (b) has an average functionality of 2.3 to 3.5.

10. The process according to claim 1, wherein the auxiliaries and additives comprise a mold release agent.

11. A compact, transparent polyurethane obtained by the process of claim 1.

12. A surface coating comprising the compact, transparent polyurethane according to claim 11.

13. A glass, wood, carbon fiber, glass fiber, or plastic surface coated with the surface coating of claim 12.

14. A wood surface coated with the surface coating of claim 12.

15. The process according to claim 1, comprising mixing the auxiliary.

16. The process according to claim 1, comprising mixing the additive.
